(19) United States
(12) Patent Application Publication
(10) Pub. No.: US 2007/0106942 A1
(43) Pub. Date: May 10, 2007

(54) Information display system, information display method and storage medium storing program for displaying information

(75) Inventors: Chikako Sanaka, Kanagawa (JP); Shinichi Maekawa, Kanagawa (JP); Masako Kitazaki, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/443,202

(22) Filed: May 31, 2006

(30) Foreign Application Priority Data
Nov. 4, 2005 (JP) 2005-320528

(51) Int. Cl. G06F 9/00

(52) U.S. Cl. 715/733; 715/781; 715/764; 715/741

(57) ABSTRACT

An information display system includes a display that displays information in a display area and a controller that defines, as a personal information display area, part of the display area of the display.

This application claims the benefit of Japanese Patent Application No. 2005-320528 filed in Japan on Nov. 4, 2005, which is hereby incorporated by reference.

### BACKGROUND

1. Technical Field

The present invention relates to an information display system, an information display method and a storage medium storing a program for displaying information that support the collaborative work and the like of plural users.

2. Related Art

In recent years, there has been a growing trend for people to bring their personal computers to meetings and the like to exchange data. In such cases, people exchange data by storing the data to be exchanged in a portable external storage medium such as a USB memory and providing the recipient of the data with the external storage medium, so that the recipient can transfer the data from the external storage medium to his/her own personal computer.

### SUMMARY

According to an aspect of the invention, an information display system includes a display that displays information in a display area; and a controller that defines, as a personal information display area, part of the display area of the display.

### BRIEF DESCRIPTION OF THE DRAWINGS

An exemplary embodiment of the present invention will be described in detail below based on the following figures, wherein:

FIG. 1 is a schematic diagram showing an example of an information display system pertaining to the exemplary embodiment of the invention;

FIG. 2 is a block diagram showing an example of the configuration of the information display system pertaining to the exemplary embodiment of the invention;

FIG. 3 is an explanatory diagram showing an example of contents displayed by a display device of the information display system pertaining to the exemplary embodiment of the invention;

FIG. 4 is an explanatory diagram showing an example of an operation in the information display system pertaining to the exemplary embodiment of the invention;

FIGS. 5A to 5C are explanatory diagrams showing other examples of operations in the information display system pertaining to the exemplary embodiment of the invention;

FIGS. 6A to 6D are explanatory diagrams showing examples of displays in the information display system pertaining to the exemplary embodiment of the invention; and

FIGS. 7A and 7B are explanatory diagrams showing examples of displays in the information display system pertaining to the exemplary embodiment of the invention.

### DETAILED DESCRIPTION

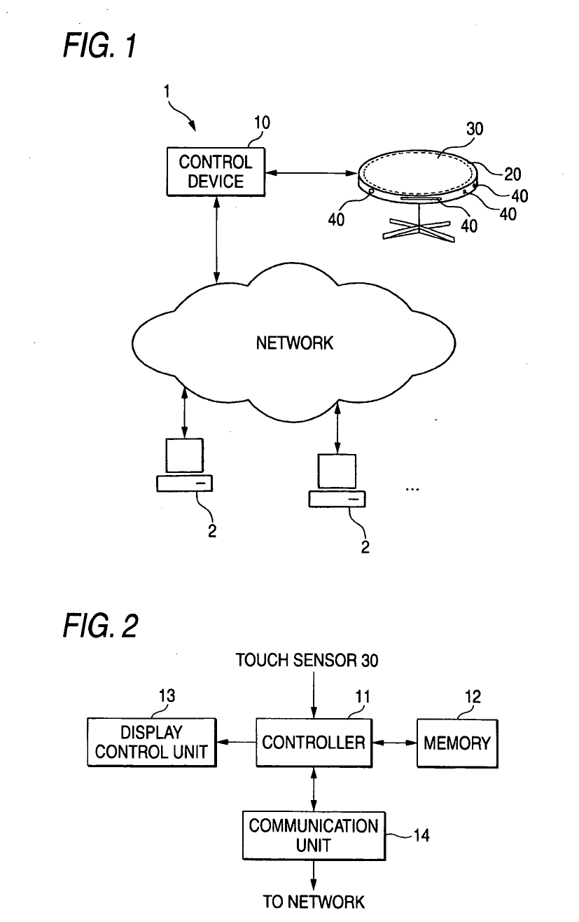

An exemplary embodiment of the present invention will now be described with reference to the drawings. As shown in FIG. 1, an information display system 1 of this exemplary embodiment is configured to include a control device 10, a display device 20, a touch sensor 30 overlaid on a display surface of the display device 20, and tag readers 40. Further, the information display system 1 is connected to computer devices 2 of users via a network. It will be noted that in this exemplary embodiment, the computer devices 2 of the users may also be remotely disposed from the information display system 1.

The control device 10 is a common server computer. As shown in FIG. 2, the control device 10 is configured to include a controller 11, a memory 12, a display control unit 13, and a communication unit 14. Here, the controller 11 is a CPU or the like and operates in accordance with a program stored in the memory 12. The controller 11 executes: (1) shared information management for retaining shared information and controlling the display of information pertaining to that shared information; (2) user authentication for authenticating users; and (3) personal information management for accessing the computer devices 2 of the users, acquiring personal information pertaining to those users (referred to below as “personal information”), and controlling display pertaining to that personal information when the controller 11 receives an instruction from the users present in the vicinity of the display device 20. These actions will be described in detail later.

The memory 12 is a computer-readable storage medium, such as a storage element like a RAM or ROM or a disk device like a hard disk, that retains the program executed by the controller 11. The memory 12 also operates as a work memory for the controller 11.

The display control unit 13 controls the display device 20 in accordance with an instruction inputted from the controller 11, and causes the data instructed from the controller 11 to be displayed/outputted. The communication unit 14 is a network interface that transmits data to, and receives data from, the computer devices 2 via the network.

The display device 20 may be a liquid crystal or CRT display device, for example, or may be a projection display including a projector and a screen. The display device 20 displays information in accordance with an instruction from the control device 10. In this exemplary embodiment, the display device 20 is configured such that it displays information on the top portion of a table, as shown in FIG. 1. That is, the display device 20 may be configured such that a glass plate serving as a tabletop is used as a protective plate, so that a liquid crystal display disposed underneath can be seen through the glass plate. Or, the display device 20 may be configured such that the tabletop has ground glass and information is projected with a projector from below.

The touch sensor 30 is overlaid on the display surface of the display device 20. When the display device 20 is disposed such that it serves as the top of a table as in this exemplary embodiment, the touch sensor 30 is realized as a device that detects where the fingers of the users contact the top portion. As the touch sensor 30 a widely known touch sensor, such as a panel disposed with transparent electrodes, for example may be used.

The tag readers 40 detect, without contacting, IC tags that the users attach to themselves. In this exemplary embodiment, it will be assumed that the users have IC tags in which information identifying each of the users is recorded, such as the names of the users. In this exemplary embodiment, the plural tag readers 40 are disposed on the outer periphery of the display device 20 (i.e., on the outer periphery of the top of the table), acquire information from the IC tags of the users present in the vicinity of the display device 20 in accordance with an information acquisition instruction inputted from the control device 10, and output the acquired information to the control device 10.

The computer devices 2 of the users are common personal computers, but here, a server application for providing an interface screen via the network is installed in the computer devices 2. That is, when the computer devices 2 receive a request for an interface screen via the network from the information display system 1 or the like, the computer devices 2 transmit interface screen information to the requester in response to that request. A widely known server application, such as the Virtual Network Computing (VNC) software developed by RealVNC (see http://www.realvnc.com), can be used as the server application.

With this server software, when an operation is conducted where a file is selected by a mouse or keyboard operation received via a network, reference information (a URL or the like) relating to the selected file is transmitted to the client.

Next, the operation of the controller 11 will be described.

Shared Information Management and Personal Information Management

The controller 11 executes ordinary operating system processing including graphical user interface (GUI) processing, and displays, in a predetermined area (shared information display area) on the display device 20, an image to be displayed by the GUI processing.

Further, the controller 11 receives the content of an instruction operation that a user has conducted on the display screen of the display device 20, and conducts processing in accordance with that instruction. In this exemplary embodiment, instead of the user operating a mouse or keyboard, the user directly touches the touch sensor 30 with his/her fingers to move a cursor or to input characters or the like, which corresponds to key input. For example, when the user places his/her finger on the touch sensor 30 and releases his/her finger from the touch sensor 30 (tapping), this corresponds to the user moving a cursor with a mouse to, and clicking on, that position. Further, when the user twice taps a certain place on the touch sensor 30 with his/her finger, this corresponds to moving a cursor with a mouse to, and double-clicking on, that place. Moreover, when the user places his/her finger on a point on the touch sensor 30 and slides his/her finger on the touch sensor 30 from that point to another point (while maintaining contact with the touch sensor 30), this corresponds to dragging with a mouse. Because such operations using the touch sensor 30 can be recognized in the same manner as operations with tablet PCs and various kinds of portable digital assistants (PDA), detailed description thereof will be omitted here.

The controller 11 may also execute predetermined processing in correspondence to predetermined operations that the user has conducted on the touch sensor 30. This processing is known as “gesture command.” Further, the controller 11 may also recognize characters and figures that the user has drawn by moving his/her finger on the touch sensor 30, and conduct processing on the basis of the result of that recognition. The processing for recognizing characters and figures drawn in a free area in this manner can utilize the technology in, for example, the Newton® Message Pad PDAs made by Apple Computer, Inc.

Further, the controller 11 executes processing of client software (e.g., a VNC client), which corresponds to the server that services the interface screens operating on the computer devices 2, and displays a VNC client window in a display area (personal information display area) that the user has designated.

One of the characteristics in this exemplary embodiment is that when a user touches the touch sensor 30 with his/her finger so that a file being displayed in the shared information display area is selected by that operation, and when a file on one of the computer devices 2 that is displayed in the personal information display area is selected (in this case, the URL of the file selected from the computer device 2 is transmitted) and the user moves his/her finger (without removing his/her finger from the touch sensor 30), this operation is processed as dragging or is processed as the drawing of a character or figure if a file has not been selected.

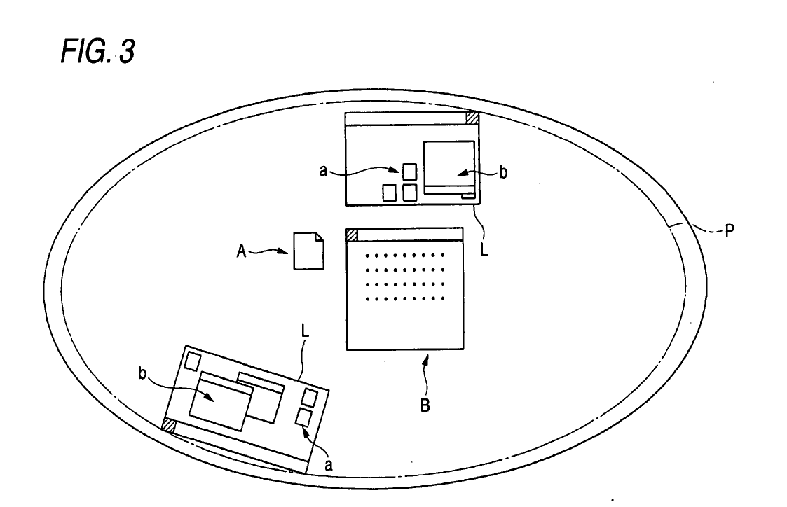

In other words, as shown in FIG. 3, the controller 11 displays on the display device 20 a shared information display area (P) and personal information display areas (L) of the users. Here, an example is shown where the personal information display areas (L) are superposed on the shared information display area (P) (i.e., an example where the windows of the personal information display areas (L) are displayed with the shared information display area (P) serving as a background), but the personal information display areas (L) may also be set separately from the shared information display area (P). Further, the plural shared information display areas (P) may be set rather than just one. In this case, mutually different access rights (the right to copy files to the shared information display areas, the right to browse files within the shared information display areas, etc.) may be set for the respective shared information display areas (P).

In the shared information display area (P), the controller 11 displays icons or the like of data files stored in the memory 12 (A). Image data of documents when data files in the memory 12 are opened with application programs is also displayed (B).

Similarly, screens generated by the corresponding computer devices 2 are displayed in the personal information display areas (L). Here, icons (a) of files in the computer devices 2 of the users, and images (b) of documents opened by application programs executed in the computer devices 2 of the users, are displayed.

Dragging between Personal Information Display Areas and Shared Information Display Area

Here, processing by the controller 11 when a user drags the icon of a file displayed in his/her personal information display area to the shared information display area (P) will be described.

When a user first selects a file within his/her personal information display area (L), the controller 11 receives reference information (such as the URL of the selected file) from the corresponding computer device 2 and recognizes that the operation next conducted by the user of moving his/her finger is dragging.

The controller 11 tracks the movement of the user's finger and displays the locus of that movement when the user's finger leaves the personal information display area (L). Then, the controller 11 checks whether or not the position to which the user's finger has moved is in the shared information display area (P). Here, if the position to which the user's finger has moved is in the shared information display area (P), then the controller 11 requests, from the corresponding computer device 2, the actual file with respect to the received reference information such as the URL. This request is conducted using the File Transfer Protocol (FTP), for example. In this case, the server corresponding to the request (e.g., an FTP server) is started in each computer device 2. Then, the controller 11 receives the corresponding file from the computer device 2, stores the file in the memory 12, and displays an icon corresponding to that file within the shared information display area (P).

When a user selects a file within the shared information display area (P), the controller 11 recognizes that the operation next conducted by the user of moving his/her finger is dragging.

The controller 11 tracks the movement of the user's finger and displays the locus of that movement when the user's finger leaves the shared information display area (P). Then, the controller 11 checks whether or not the position to which the user's finger has moved is in the personal information display area (L). Here, if the position to which the user's finger has moved is in the personal information display area (L), then the controller 11 transmits, to the computer device 2 corresponding to that personal information display area (L), reference information such as the URL of the file that the user has selected. The computer device 2 receives this reference information and may also transmit a request for that file to the control device 10. This request is also conducted using the File Transfer Protocol, for example. In this case, the controller 11 of the control device 10 executes processing of the server corresponding to the request as an FTP server, for example. Then, when the computer device 2 receives the corresponding file from the control device 10, the computer device 2 stores the file in a storage area such as a hard disk and updates the display of the screen such that an icon corresponding to that file is displayed within the personal information display area (L).

The file initially designated by the user when these operations are conducted may be deleted or left as is without being deleted. If the file is deleted, then the file can be treated as if it has simply been moved between the shared information display area (P) and the personal information display area (L). If the file is not deleted, then the shared information display area (P) and the personal information display area (L) are distinguished as separate areas and the file is copied when it is moved between the areas. The information display system 1 may also be configured such that when a user drags an icon from his/her personal information display area (L) to the shared information display area (P), for example, then the file represented by that icon is copied (i.e., the original file that has been selected is not deleted), and when a user drags an icon from the shared information display area (P) to his/her personal information display area (L), then the file represented by that icon is moved (i.e., the original file that has been selected is deleted).

The information display system 1 may also be configured such that when a user drags an icon from his/her personal information display area (L) to the shared information display area (P), then the file that has been copied or moved to the shared information display area (P) is opened with an application program and displayed. Further, the information display system 1 may be configured such that when a user drags the window of a document opened in the shared information display area (P) (when the user drags a portion (e.g., the title bar portion) predetermined as a draggable area in the window) to his/her personal information display area (L), then the controller 11 transmits to the computer device 2 reference information such as the URL of the file corresponding to that document, the computer device 2 receives that reference information, transmits a request for that file to the control device 10, and moves the file to the computer device 2.

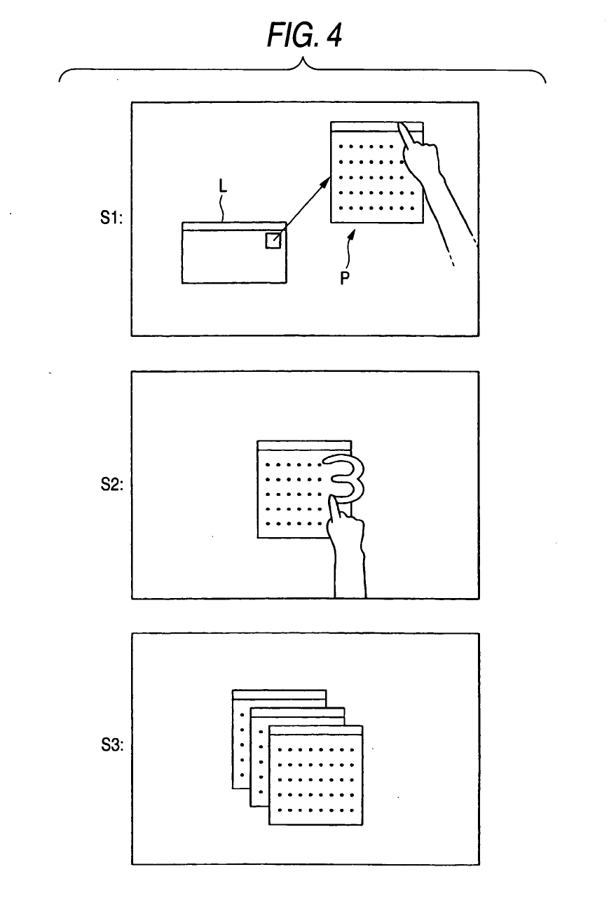

Moreover, the controller 11 may be configured such that when a user uses his/her finger to draw, originating within a document window while that document window is open in the shared information display area (P), a character recognizable as a number, then a number of copies represented by that number is made of the file corresponding to the document window, the copied files are opened with an application program, and at least part of the copied files are displayed over the original document window (FIG. 4). When the user drags the documents of the windows opened by copying to his/her personal information display area (L), then the controller 11 closes the windows of the documents corresponding to the files that have been deleted as a result of being moved. FIG. 4 shows:

(S1) a scene where a user drags the icon of a file from his/her personal information display area (L) to the shared information display area (P), the file is copied, and a document window is opened by an application program;

(S2) a scene where the user draws the number “3” on the document window displayed in the shared information display area (P); and

(S3) a scene where the document is copied a number of times equal to the number displayed by the drawn number, and the copied documents are opened in separate windows.

It will be noted that the manner in which the personal information display areas (L) and the shared information display area (P) are displayed may also be varied, by drawing borderlines or varying the colors within the areas, such that the fact that they are mutually different areas can be visually recognized.

Defining the Personal Information Display Areas

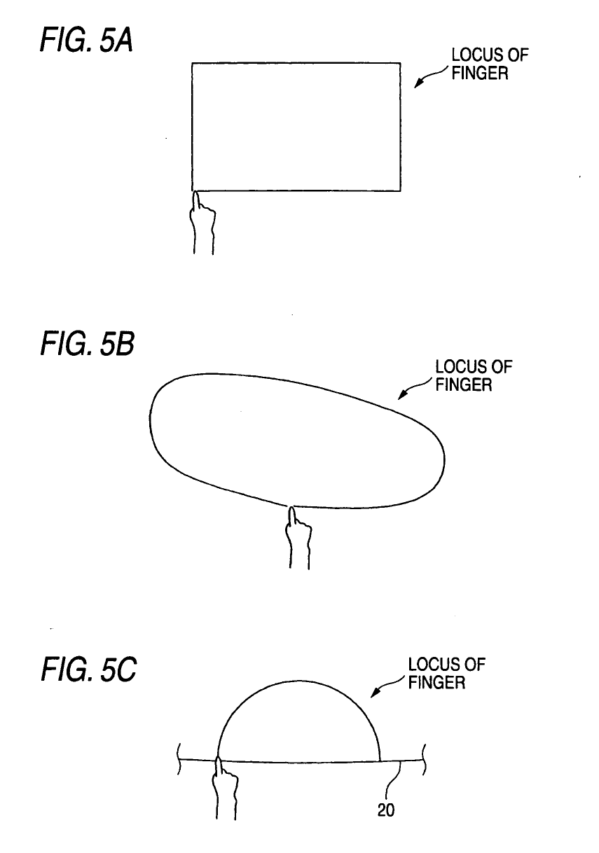

The personal information display areas (L) may be defined by a predetermined operation conducted by the user on the touch sensor 30. Here, the predetermined operation may be one where the user draws a rectangle (FIG. 5A) or one where the user defines an area with an arbitrary figure (FIGS. 5B and 5C) on the touch sensor 30. Here, when the user defines an area with an arbitrary figure, the user may do so by drawing a circle, as shown in FIG. 5B, or by using the peripheral edge portion of the touch sensor 30 as the edge of the area and moving his/her finger from one point on the peripheral edge portion to another point, as shown in FIG. 5C.

When the user defines the personal information display area (L) by drawing a rectangle, then the area inside that rectangle is used as the personal information display area (L). When the user defines the personal information display (L) with an arbitrary figure, as in FIGS. 5B and 5C, then a rectangle inscribed in or circumscribed by that arbitrary figure is defined as the personal information display area (L).

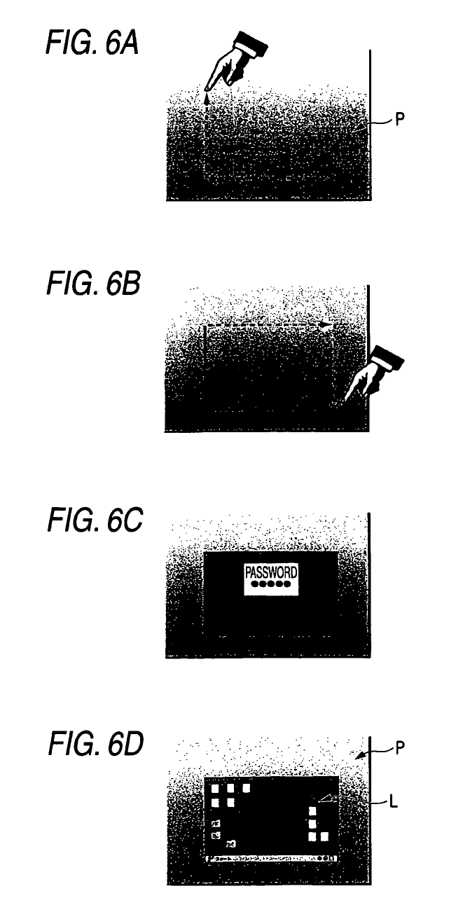

In other words, when the user uses his/her finger to draw a rectangle in the shared information display area (P) (FIGS. 6A and 6B), then his/her personal information display area (L) is set and the user is requested to input a password (FIG. 6C), for example. Here, if the appropriate password is inputted, a user desktop or the like is displayed in the personal information display area (L) (FIG. 6D).

User Authentication

In this exemplary embodiment, the controller 11 may also conduct processing to authenticate the user, because it is necessary for the controller 11 to access the computer device 2 of each user. This authentication may be conducted by prompting the user to input his/her name or a password. Alternatively, a device for conducting biometric authentication, such as a fingerprint authenticating device or a vein authenticating device, may be disposed in the vicinity of the display device 20, and the device may conduct user authentication and user name acquisition with this biometric information.

Further, when an image of the fingertips or palm of the hand of a user is to be taken for fingerprint authentication or vein authentication, authentication may be conducted as a result of the user placing his/her fingertips or palm of the hand on a glass surface covering the display device 20, for example. In this case, a guide image representing the region where the user should place his/her hand is displayed, and that portion of the user's body is imaged with visible light or infrared light while the user is resting his/her fingers or hand on the glass surface. Various kinds of existing technology can be used for the method of fingerprint or vein authentication.

Moreover, authentication using handwritten characters (such as the signature of the user), voiceprint authentication, or various other kinds of authentication may be used as the method of biometric authentication.

The information display system 1 may also be configured such that the controller 11 correlates users and information identifying the computer devices 2, retains this in the memory 12, and transmits the result of the biometric authentication to the computer device 2 identified by the information correlated with the authenticated user. The computer devices 2 may also be configured to not provide images to be displayed in the personal information display areas (L) until they receive the result of the authentication.

Moreover, here the information display system 1 may be configured such that the controller 11 detects the orientation of the palm of the hand of the user as the position or orientation of the user, and uses the detected position or orientation to determine the orientation of the personal information display area (L) or the display orientation of a document within the personal information display area (L). For example, the controller 11 may determine the orientation of the personal information display area (L) using the longitudinal direction of the palm of the user's hand (usually, an orientation joining the elbow and the fingertips when the user's fingers are aligned) as a vertical orientation and the palm side as a downward direction.

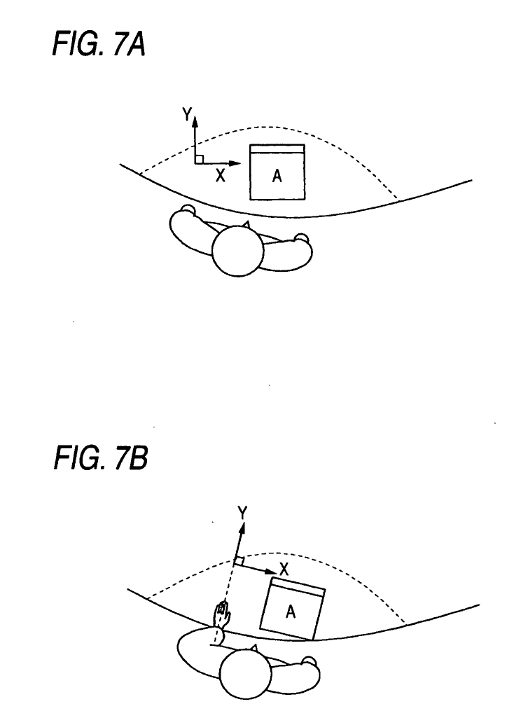

Specifically, in an imaging model in a common graphical user interface (software module that draws on a screen or the like), the display coordinate system is rotated so that the Y axis becomes parallel to the line leading from the fingertips of the hand to the palm of the hand. Thus, the window of the document is displayed along this orientation of the palm of the hand (FIGS. 7A and 7B).

Here, an example was described where the position or orientation of the user was discriminated by the orientation of the hand, but the information display system 1 may also be configured such that, for example, a human sensor (pyroelectric sensor or the like) is attached to the periphery of the top portion of the display device 20, the seat position of the user is detected by this human sensor, and the coordinates within the defined personal information display area are rotated or moved in parallel on the basis of the detected position.

In this exemplary embodiment, when plural personal information display areas (L) are defined, the positions and orientations of the users are detected for each personal information display area, and not just the environment of the users (screens or the like acquired by VNC or the like) but information such as the inclination of the coordinate systems or the like is correlated and stored. Then, the display orientation of a document within the personal information display areas (L) and the like is controlled on the basis of this stored information.

Processing when a User has left His/Her Seat

The controller 11 requests, per predetermined timing (e.g., periodically), the tag readers 40 to acquire information. Then, using the information that the tag readers 40 have acquired, the controller 11 generates a list of the users who are present in the vicinity of the display device 20 as the list of users present.

The controller 11 stores in the memory 12 a list of the users relating to the personal information display areas (L). Then, when the controller 11 detects, of the users included in the user list, a user who has not been included in the list of users present, the controller 11 instructs the computer device 2 pertaining to the detected user to lock its screen. The computer device 2 receives this instruction and locks the screen or activates a screensaver or the like. The computer device 2 continues locking the screen until authentication is conducted by the controller 11 as a result of the user again inputting his/her user name or password and the computer device 2 receives information indicating that the authentication was successful.

During the period of time when the screen is locked or the screensaver is activated, the computer device 2 may also display in the personal information display area (L) information identifying the user (the user name, or an image such as a photograph of the user if such an image has been registered).

Examples of the screensaver include an arbitrary moving image, a list of files, or an image where the GUI screen is shaded (made somewhat darker to indicate the fact that the computer device 2 is inoperable).

Technology Usable in Fingerprint Authentication or Signature Authentication

An example of a configuration for acquiring fingerprint images when the user places his/her fingers in a region larger than the area of his/her fingertips like the display surface of the display device 20 in this exemplary embodiment is disclosed in JP-A-2003-323605, and an example of a configuration for signature authentication is disclosed in JP-A-11-144056. Moreover, an example of a method using an IC card or the like to authenticate users is disclosed in JP-A-2004-234632. Disclosures of these three documents are hereby incorporated by reference in their entities.

Modification

In this exemplary embodiment, the users present in the vicinity of the display device 20 are identified by IC tags or the like, but instead of this, the information display system 1 may be configured such that the users present in the vicinity of the display device 20 are photographed using a camera or the like, the movement of the users is detected using the photographed images, and processing is executed to lock the screens of the computer devices 2 in regard to personal information display areas (L) pertaining to users who have moved away from the display device 20. An example of a configuration that detects user movement is disclosed in JP-A-2005-115544, which is hereby incorporated by reference in its entity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information display system comprising:
a display that displays information in a display area; and
a controller that defines, as a personal information display area, part of the display area of the display.

2. The information display system of claim 1, further comprising an operational unit that receives an operation of a user, wherein the controller defines the personal information display area when a specific operation has been conducted on the operational unit.

3. The information display system of claim 1, further comprising an authenticating unit that authenticates a user, wherein the controller defines the personal information display area when authentication has been conducted by the authenticating unit.

4. The information display system of claim 2, further comprising a position detecting unit that detects the position of the user, wherein the controller defines the personal information display area on the basis of the position detected by the position detecting unit.

5. The information display system of claim 3, further comprising a position detecting unit that detects the position of the user, wherein the controller defines the personal information display area on the basis of the position detected by the position detecting unit.

6. The information display system of claim 2, further comprising an orientation detecting unit that detects the orientation of the user, wherein the controller defines the personal information display area on the basis of the orientation detected by the orientation detecting unit.

7. The information display system of claim 3, further comprising an orientation detecting unit that detects the orientation of the user, wherein the controller defines the personal information display area on the basis of the orientation detected by the orientation detecting unit.

8. The information display system of claim 1, wherein the controller defines a plurality of personal information display areas.

9. The information display system of claim 1, wherein the controller defines, as a shared information display area, at least part of the display area of the display.

10. An information display method comprising:
displaying information in a display area; and
defining, as a personal information display area, part of the display area.

11. The information display method of claim 1, further comprising:
receiving an operation of a user, wherein the personal information display area is defined when a specific operation has been received.

12. The information display method of claim 11, further comprising:
authenticating a user, wherein the personal information display area is defined when authentication has been successfully conducted.

13. A storage medium readable by a computer, the storage medium storing a program of instructions executable by the computer to perform a function for displaying information, the function comprising:
displaying information in a display area; and
defining, as a personal information display area, part of the display area.

14. The storage medium of claim 13, the function further comprising:
receiving an operation of a user, wherein the personal information display area is defined when a specific operation has been received.

15. The storage medium of claim 13, the function further comprising:
authenticating a user, wherein the personal information display area is defined when authentication has been successfully conducted.
